(19) United States
(12) Patent Application Publication
(10) Pub. No.: US 2026/0039722 A1
(43) Pub. Date: Feb. 5, 2026

(54) SYSTEMS AND METHODS FOR PRIVACY ENHANCED SOCIAL NETWORKING

(71) Applicant: Glimpsters, Inc., Burlington, MA (US)

(72) Inventor: Stanley Fredericq, Burlington, MA (US)

(73) Assignee: Glimpsters, Inc., Burlington, MA (US)

(21) Appl. No.: 19/279,291

(22) Filed: Jul. 24, 2025

Related U.S. Application Data
(60) Provisional application No. 63/677,802, filed on Jul. 31, 2024.

(51) Int. Cl. H04L 67/306; G06Q 50/00

(52) U.S. Cl. CPC H04L 67/306; G06Q 50/01

(57) ABSTRACT

A system and method for privacy-enhanced social networking may include dynamically managing user privacy and identity through multiple user profile aliases by defining each alias with a specific subset of user information and context parameters, such as location, proximity to other users, or participation in events. The system may dynamically select and display the appropriate alias based on the user's current context, thereby ensuring context-sensitive visibility of user information. Features include geofencing, proximity-based networking, and event participation tracking, supported by advanced system architectures such as graph databases and machine learning models. Additional functionalities include privacy-enhanced messaging with facial recognition for recipient verification, anonymous gifting, and automated will execution. A map interface and real-time adaptability further enhance user engagement and privacy management, fostering secure, meaningful interactions while maintaining robust privacy controls for applications in professional networking, community events, and confidential communications.

### CROSS-REFERENCE TO RELATED APPLICATIONS

This application claims priority to U.S. Provisional Application 63/677,802, filed Jul. 31, 2024 and title “SYSTEMS AND METHODS FOR PRIVACY ENHANCED SOCIAL NETWORKING,” which is incorporated herein by reference in its entirety.

### FIELD OF TECHNOLOGY

The present disclosure generally relates to systems and methods of privacy-enhanced social networking, including context-aware user profile aliasing and dynamic privacy controls to improve user privacy within social networking technologies.

### BACKGROUND OF TECHNOLOGY

Social media provides users an ability to register and create a profile by providing personal information such as name, contact information, educational information, employment information, and photographs. Users can also upload status messages, links to web content, blogs, etc. Some user information and content are available to the public, while some are only available to connected users.

The social media platform typically includes the ability for users to identify and establish connections with other users based on various factors such as location, preferences, language, gender, and professional interests. Connections are typically formed through an invitation process, and once connected, users can view each other's personal content, communicate with each other, and view contents published by them or contents of particular interest to them. Thus, the social media platform facilitates the building of social networks or social relations among users, providing a platform for users to interact with each other in the virtual world.

### SUMMARY

In some embodiments, the present disclosure provides a technically improved computer-based method that includes at least the following steps of: storing, in a primary user profile of a first user, a plurality of user profile aliases, each alias being associated with a respective subset of user information and a corresponding context parameter; determining a current context for the first user based on one or more context criteria selected from at least one of: (a) the location of a first user device, (b) the proximity between the first user device and a second user device, or (c) participation in an event defined by a community participation event data object; selecting, based at least in part on the determined current context and the stored context parameters, one of the user profile aliases; and causing a user interface on the second user device to display only the subset of user information associated with the selected alias.

In some embodiments, the present disclosure provides a technically improved computer-based system that includes components such as at least one non-transitory computer-readable medium storing program instructions and at least one processor in communication with the non-transitory computer-readable medium. The processor may be configured to execute the instructions to: store a plurality of user profile aliases in a primary user profile of a first user, each alias being associated with a respective subset of user information and a corresponding context parameter; determine a current context for the first user based on one or more context criteria selected from at least one of the following: the location of a first user device, the proximity between that device and a second user device, or participation in an event defined by a community participation event data object; select a profile alias based at least in part on the current context and the associated context parameter; and cause a user interface on the second user device to display only the subset of user information tied to the selected alias.

These and other features will be more fully understood from the following detailed description and accompanying drawings.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of another exemplary social media platform 100 in accordance with one or more embodiments of the present disclosure.

FIG. 2 depicts illustrative schematics of an exemplary implementation of a cloud platform 125 hosting the social media platform 100 in accordance with some embodiments of the present disclosure.

### DETAILED DESCRIPTION

Systems and methods detailed herein provide improvements to social media via improved privacy and location-based features that enable users to better control who can see what of their information and in what contexts. As such, embodiments herein provide transitory, event-based communicate for lasting community connection.

To do so, embodiments described herein include user profile aliasing with the ability to control what version of a user's identity is visible to others on the platform and in what contexts. Indeed, typical social media platforms allow users to make a single user profile, and any followers that the user authorizes gains visibility into that user profile. However, users may often have different aspects of their identity that is more appropriate for some contexts as opposed to other. Thus, aspects of embodiments herein include a user profile having multiple aliases, each one correlated to particular contexts, followers, locations or other factors or any combination thereof. Thus, a user may specify which version of their identity is presented in which contexts, such as a professional version of their profile appearing for professional followers, at locations associated with business or employment related activities, or according to any other factors to which the professional alias may be mapped. Similarly, the user may have other aliases for, e.g., friends, family, community outreach, use as a public persona and/or celebrity, use as a business, use as a merchant, use as a customer, among other contexts or any combination thereof.

Furthermore, a user's profile may be controllably visible or private based location and/or participation in events. Indeed, a user may generally wish to be kept private, but for particular events may desire some or all of their followers to have visibility into the user's presence at a particular location. For example, the user may wish to participate in a community event that includes networking with others at the event in a physical location, and thus may have an alias or other setting that is configured to present the user's information while in the area of the community event.

Indeed, such community events may interact with user profiles so as to enable contest or other group participation events to be organized. The group participation events may allow users to participate by enrolling n the event such that a desired user profile may be associated with the event and the user's participation may be made visible and/or tracked on the platform to enable the performance of the group participation event. Where other social media may require a user to be either private or public regardless of location and participation in the event, embodiments herein may include context dependent visibility based on the event, the location of the event and the user's participation thereon.

Further, a user's visibility to non-followers may be controlled based on location, including proximity to other users. People often like to meet in public places and network with those in the area. However, other social media companies fail to provide functionality that matches this context, requiring a user that meets another to explicitly make their profile available to the other, either by exchanging specified information, sending an invite, or other mechanism. However, embodiments herein may instead adjust the user's profile alias so as to provide a public alias that strangers may see when in proximity to the user, thus enabling proximity based on networking. Moreover, such public alias may disappear from visibility when the proximity is no longer there, thus protecting even the public information of the user from general discovery when the proximity is achieved.

Social media platforms have become a foundational part of modern communication, enabling users to share personal information, connect with others, and participate in virtual communities. However, existing platforms often lack robust privacy controls and context-sensitive features, leaving users with limited options to manage their digital identities. Conventional systems typically allow users to create a single profile, which is uniformly visible to all authorized connections, regardless of the context or relationship. This one-size-fits-all approach fails to address the nuanced privacy needs of users, such as presenting different aspects of their identity to professional contacts, friends, or family. Additionally, existing platforms do not adequately support location-based or event-specific interactions, often requiring users to manually adjust privacy settings or share sensitive information to participate in community events or proximity- based networking. These limitations expose users to privacy risks, reduce engagement in location-based activities, and hinder the formation of meaningful, context-driven connections.

The present disclosure addresses these shortcomings by introducing systems and methods for privacy-enhanced social networking, leveraging user profile aliasing, context-aware privacy controls, and advanced system architectures. The described approach enables users to create multiple profile aliases, each tailored to specific contexts, relationships, or locations. For example, a user can maintain a professional alias for workplace interactions, a personal alias for friends and family, and a public alias for networking events. These aliases are dynamically managed based on contextual parameters such as location, proximity to other users, or participation in events, ensuring that only the appropriate subset of user information is shared in each scenario. This approach enhances user privacy while fostering more meaningful and secure interactions.

The solution is supported by a sophisticated system architecture that includes graph databases for managing user relationships, machine learning models for content recommendations, and message queue technologies for scalable, real-time communication. The use of graph databases allows for efficient mapping of user connections and dynamic switching between profile aliases, while machine learning models improve user engagement by delivering personalized content. Additionally, the system incorporates location-based features, such as map interfaces and geofencing, to enable proximity-based networking and community participation events. These events can include contests or group activities with configurable thresholds for participation, further encouraging user engagement. By integrating these technical advancements, the described system provides a comprehensive approach that addresses the limitations of conventional social media platforms, offering enhanced privacy, contextual adaptability, and improved user experiences.

By determining a first location of a first user and a second location of a second user based on respective user devices, the disclosed method enables precise and real-time identification of user positions. Such an arrangement ensures that location data is dynamically updated and accurately reflects current user positions within the system.

The application of at least one proximity requirement between the first and second locations introduces a context-sensitive mechanism for filtering location data according to predefined criteria. This approach reduces unnecessary data sharing and ensures that only relevant location information is processed and displayed, thereby enhancing both privacy and system efficiency.

Integration of a map interface on the first user device, configured to present an indication of the second user being present at the second location, provides a visual and intuitive representation of proximity-based interactions. This feature facilitates real-time, location-aware social networking by enabling identification and connection with other users in the vicinity without requiring manual input or intervention.

Unlike conventional systems that rely on manual sharing of location data or static privacy settings, the disclosed method dynamically adapts to proximity and context. Such dynamic adaptation improves user experience by automating the visibility of location-based interactions while maintaining granular control over privacy parameters.

For instance, during a professional networking event, the system may automatically display the presence of nearby attendees on the map interface, thereby enabling identification and engagement with relevant individuals without necessitating prior connections or manual location sharing. This capability enhances the practical utility of the platform in location-specific scenarios and supports the formation of meaningful, context-driven connections.

Techniques herein enables dynamic facilitation of community participation events by utilizing a community participation event data object specifying event parameters, including a location, a participation threshold, and at least one associated prize. Broadcasting the event data object to a community of users ensures widespread awareness and engagement with the event. Measurement of participation is performed through predefined metrics, such as user presence at the specified location, allowing for real-time tracking and evaluation of community involvement.

This arrangement provides a scalable and automated mechanism for managing event participation, thereby reducing the need for manual oversight. Implementation of a participation threshold ensures that rewards or prizes are issued only when a predetermined level of engagement is achieved, optimizing resource allocation and incentivizing collective user activity. For example, a business hosting a promotional event can track user presence and issue rewards only when a sufficient number of users participate, thereby maximizing event impact while minimizing unnecessary expenditures.

Integration of location-based tracking ensures that participation is directly correlated with the event's physical setting, thereby enhancing the authenticity and effectiveness of user engagement. This feature is particularly advantageous for events such as fundraisers, contests, or promotional campaigns, where physical presence is a critical factor. Automated issuance of prizes upon meeting the participation threshold streamlines the reward process, improves user satisfaction, and reduces administrative complexity for event organizers.

Techniques herein enable dynamic and context-sensitive management of user privacy by associating user activities with specific user profile aliases. Such an arrangement allows the system to tailor the visibility of user information based on the context of the activity, including activity type, location, or involvement of other users. As a result, improved control over digital identity is achieved, ensuring that only relevant information is shared in specific scenarios. By determining the appropriate user profile alias based on context parameters specified in a master user profile, the system eliminates the need for manual adjustments to privacy settings. This automation reduces user effort and minimizes the risk of accidental exposure of sensitive information, thereby enhancing both privacy and usability.

Utilization of context parameters, such as activity type, location, or associated users, enables granular customization of privacy settings. For example, a professional profile alias may be presented during work-related activities, while a personal profile alias may be presented during social interactions. This flexibility supports diverse use cases and ensures that the system adapts to varying privacy requirements.

Implementation of privacy controls based on user profile aliases ensures that the system dynamically enforces privacy rules in real-time. For instance, upon entry into a specific location or engagement in an activity with another user, the system can automatically adjust the visibility of user information. Such real-time adaptability enhances the practical utility of the platform in dynamic environments.

The method leverages the master user profile as a centralized repository for context parameters, enabling efficient management and retrieval of user preferences. This architecture reduces computational overhead and ensures consistent application of privacy settings across different contexts.

Practical applications include scenarios such as professional networking events, where a professional profile alias is automatically activated, or social gatherings, where a personal profile alias is used. This capability fosters meaningful interactions while maintaining robust privacy protections.

Techniques herein include a mechanism for enhancing privacy and security in messaging sessions by leveraging facial recognition technology to verify the identity of the recipient user. By controlling the camera of the recipient user device to capture an image of the recipient and enforcing privacy controls based on the verification results, the system ensures that sensitive information is only accessible to the intended recipient.

This arrangement provides a practical solution to prevent unauthorized access to private communications. The use of facial recognition models to confirm the recipient's identity eliminates the reliance on manual authentication methods, which can be error-prone or inconvenient. For example, if the captured image does not match the intended recipient, the system can automatically enforce privacy measures, such as hiding or restricting access to the message content, thereby safeguarding the confidentiality of the communication.

Additionally, the integration of real-time facial recognition into the messaging session enhances the dynamic adaptability of the system. This ensures that privacy controls are applied immediately upon detecting a mismatch, reducing the risk of data exposure. For instance, in scenarios where a messaging session is accessed in a shared or public environment, the system can promptly secure the session if an unauthorized individual is detected in the camera's field of view.

The implementation of this method also enhances user trust and confidence in the platform by providing robust privacy protections. The approach addresses a common concern in digital communication-unauthorized access to sensitive information-by automating the enforcement of privacy controls based on biometric verification. This capability is especially advantageous in professional or confidential contexts, where maintaining the integrity of the communication holds significant importance.

Techniques herein enable a sender user to receive a visual confirmation of the recipient user during a messaging session by capturing and transmitting an image of the recipient user via the recipient's device camera. This arrangement provides a mechanism for enhancing the authenticity and trustworthiness of the communication by allowing the sender to visually verify the recipient's presence and engagement in real-time.

By integrating the functionality to capture and transmit the recipient's image, the system ensures that the sender can confirm the identity of the recipient without requiring additional manual verification steps. This reduces the risk of impersonation or unauthorized access to sensitive communications, thereby improving the security and reliability of the messaging session.

Additionally, the transmission of the recipient's image to the sender facilitates a more interactive and personalized communication experience. For example, in professional or confidential contexts, the sender can observe the recipient's reactions or engagement level, which may be significant for decision-making or assessing the effectiveness of the communication. This feature enhances the practical utility of the messaging platform in scenarios requiring high levels of trust and interaction.

Techniques herein enable the creation of a gift data object that is linked to an anonymized user profile alias of the sender, ensuring that the sender's identity is concealed while still allowing the gift to be associated with their account. This arrangement provides enhanced privacy for the sender, particularly in scenarios such as anonymous donations or gifting in public contexts.

By utilizing a facial recognition model to identify the recipient user in an image, the system ensures that the gift is delivered to the intended recipient with a high degree of accuracy. This eliminates the need for manual identification or input, reducing errors and streamlining the gifting process.

The generation of a recipient connection between the gift data object and a recipient user profile alias allows the recipient to receive the gift without exposing their full identity. This feature supports privacy for the recipient while maintaining the functionality of the gifting process.

The integration of facial recognition technology into the gifting process provides a secure and automated mechanism for verifying the recipient's identity. This reduces the risk of fraudulent claims or misdelivery of the gift, enhancing the reliability and trustworthiness of the system.

Practical applications include scenarios such as anonymous charitable donations, where the sender wishes to remain unidentified, or in-person gifting, where the sender can use a captured image to ensure the gift reaches the correct recipient without requiring prior connections on the platform. This capability improves the flexibility and usability of the gifting feature in diverse social and professional contexts.

Techniques herein include determining the death of a first user associated with a first user profile, the system enables automated access to a will data object without requiring manual intervention, ensuring timely and accurate execution of the user's posthumous wishes.

The association of the will data object with specific connections, such as beneficiary user profiles, executor user profiles, or family member user profiles, ensures that access to sensitive information is restricted to authorized parties. This arrangement enhances privacy and security by dynamically enforcing access controls based on predefined relationships.

The ability to control privacy parameters of the will data object ensures that only relevant parties, such as beneficiaries, executors, or family members, can access the document. This reduces the risk of unauthorized access and ensures compliance with the user's intentions.

The system's automated handling of connections to beneficiaries, executors, or family members streamlines the process of distributing the will's contents, reducing administrative overhead and potential errors. For example, upon determining the death of the user, the system can immediately notify the appropriate parties and provide access to the will data object, ensuring efficient execution of the user's estate plan.

By leveraging a centralized will data object linked to the first user profile, the system ensures consistency and integrity of the document. Any updates or modifications to the will are automatically reflected in the data object, reducing the likelihood of disputes or inconsistencies during execution.

Practical applications include scenarios where the will data object contains sensitive information, such as financial bequeathments or legal instructions. The system's ability to enforce privacy parameters ensures that such information is only accessible to the intended parties, thereby safeguarding the user's legacy and reducing the potential for misuse.

Based on such technical features, further technical benefits become available to users and operators of these systems and methods. Moreover, various practical applications of the disclosed technology are also described, which provide further practical benefits to users and operators that are also new and useful improvements in the art.

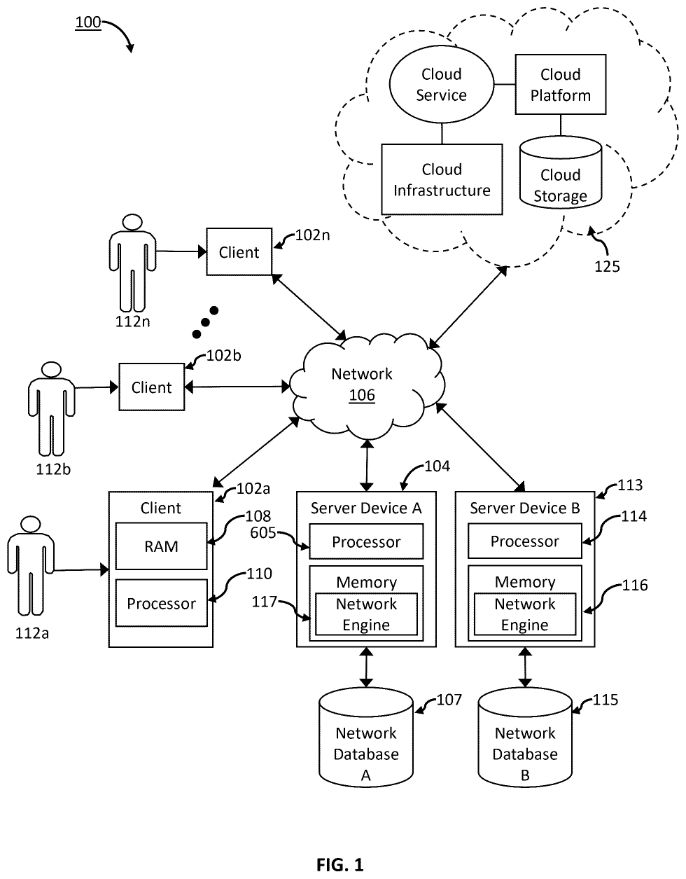

FIG. 1 depicts a block diagram of another exemplary social media platform 100 in accordance with one or more embodiments of the present disclosure. However, not all of these components may be required to practice one or more embodiments, and variations in the arrangement and type of the components may be made without departing from the spirit or scope of various embodiments of the present disclosure.

In some embodiments, a social media platform 100 may include a cloud platform for providing a social network. A social network may be characterized by functionality for users to interact in public and/or private electronic messages across users on the social media platform 100.

In some embodiments, the social network may include a user ability to post to the network of users. Such posts may be electronic messages that can be private, public, or a combination thereof. To enable posting, the social media platform 100 may include centralized and/or distributed message queues and databases to handle thousands of posts per second, ensuring real-time delivery and consistency.

Message queue technologies are a form of asynchronous service-to-service communication used in serverless and microservices architectures. They enable applications to communicate by sending messages between them without requiring a direct connection. For example, message queues may allow for asynchronous communication, meaning that the sender and the receiver do not need to interact with the message queue at the same time. Messages may be stored in the queue until the receiving application is ready to process them. Thus, message queues decouple the sender and receiver, allowing them to operate independently. This separation allows for greater flexibility and reliability in the system.

In some embodiments, the social media platform 100 may use message queues to ensure reliability. Message queues ensure that messages are not lost in the process of being sent. The message queues store the messages until the receiver processes them, which means that even if the receiver is not ready to process the message immediately, the message will not be lost. For example, if a process fails while processing a message, the message queue can return the message to the queue to be processed again. This ensures that no messages are lost due to failures.

Moreover, message queues provide a capability to handle a large volume of messages, making them highly scalable. Indeed, message queues can be especially useful in systems that experience variable loads with peaks in activity.

Additionally, message queues may facilitate ordering and timing of posts and other messages. Message queues can ensure that messages are delivered in the order they were added to the queue, or they can prioritize certain messages over others.

In some embodiments, the social media platform 100 may include a message queue technology such as, e.g., Amazon Simple Queue Service (SQS), Apache Kafka, Azure Service Bus, IBM MQ, and RabbitMQ.

In some embodiments, the social network may include a use ability to follow other users. Herein, the term “follow” refers to an association between a user's profile and the profile of other users such that one or more activities, including posts, of the other users are made available to the user via the association. As such, the term “follower” refers to those users that follow a particular user, while the term “following” refers to those users that the particular user follows.

Accordingly, the social media platform 100 may enables users to associate their profiles with other profiles so as to subscribe to other user profiles, thereby receiving the posts and other activities of the other users. In some embodiments, such received activity may be presented via a feed, including a chronological and/or algorithmically driven feed.

In some embodiments, following may be effectuated via relationships mapped between user profiles as represented by respective data objects in one or more database to form a follow graph or social graph for each user. In such a follow graph, user profiles may form nodes of the graph while relationships (e.g., follows and/or types or tiers of follows) may form edges between the nodes. Accordingly, such data may be maintained in one or more databases including graph databases and/or relational databases. In some embodiments, the database(s) may include caching layers to efficiently manage relationships and provide quick access to relevant content.

In some embodiments, the social media platform 100 may include a front end, such as an application, website and/or user interface. The front-end may provide the user the ability to see one or more feeds of posts. For example, the front-end may include a feed for the posts of followings, posts from publicly broadcast profiles, and/or the user's own posts. To do so, posts may be provided to the front-end for representation in a feed via one or more distribution systems and/or real-time data processing, such as content recommendation algorithms to deliver a dynamic stream of content including posts of other users.

In some embodiments, content recommendation algorithms may include one or more machine learning models that match content to a user based on previous user behavior. As such, the content recommendation algorithms may include collaborative filtering, content-based filtering, deep neural networks, clustering and/or hybrid systems among others or any combination thereof.

In some embodiments, collaborative filtering makes automatic predictions about the interests of a user by collecting preferences from many users. The underlying assumption is that if a user A has the same opinion as a user B on an issue, A is more likely to have B's opinion on a different issue.

In some embodiments, content-based filtering uses only information about the description and attributes of the items users has previously consumed to model user's preferences. In other words, these algorithms try to recommend items that are similar to those that a user liked in the past.

In some embodiments, deep learning models can be used for recommendation systems. They can model complex non-linear relationships and capture more intricate patterns in the data.

In some embodiments, hybrid systems may combine collaborative and content-based filtering methods to make recommendations. Hybrid systems may be more effective in some cases because they are able to overcome some of the common problems in recommendation systems, such as cold start and the sparsity problem.

In some embodiments, clustering algorithms like K-means can be used to group similar users based on their behavior and make recommendations.

In some embodiments, the client device 102a, client device 102b through client device 102n shown each at least includes a computer-readable medium, such as a random-access memory (RAM) 108 coupled to a processor 110 or FLASH memory. In some embodiments, the processor 110 may execute computer-executable program instructions stored in memory 108. In some embodiments, the processor 110 may include a microprocessor, an ASIC, and/or a state machine. In some embodiments, the processor 110 may include, or may be in communication with, media, for example computer-readable media, which stores instructions that, when executed by the processor 110, may cause the processor 110 to perform one or more steps described herein. In some embodiments, examples of computer-readable media may include, but are not limited to, an electronic, optical, magnetic, or other storage or transmission device capable of providing a processor, such as the processor 110 of client device 102a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 102a through 102n may also comprise a number of external or internal devices such as a mouse, a CD-ROM, DVD, a physical or virtual keyboard, a display, or other input or output devices. In some embodiments, examples of client devices 102a through 102n (e.g., clients) may be any type of processor-based platforms that are connected to a network 106 such as, without limitation, personal computers, digital assistants, personal digital assistants, smart phones, pagers, digital tablets, laptop computers, Internet appliances, and other processor-based devices. In some embodiments, client devices 102a through 102n may be specifically programmed with one or more application programs in accordance with one or more principles/methodologies detailed herein. In some embodiments, client devices 102a through 102n may operate on any operating system capable of supporting a browser or browser-enabled application, such as Microsoft™, Windows™, and/or Linux. In some embodiments, client devices 102a through 102n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 102a through 102n, user 112a, user 112b through user 112n, may communicate over the exemplary network 106 with each other and/or with other systems and/or devices coupled to the network 106. As shown in FIG. 1, exemplary server devices 104 and 113 may include processor 105 and processor 114, respectively, as well as memory 117 and memory 116, respectively. In some embodiments, the server devices 104 and 113 may be also coupled to the network 106. In some embodiments, one or more client devices 102a through 102n may be mobile clients.

In some embodiments, at least one database of exemplary databases 107 and 115 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

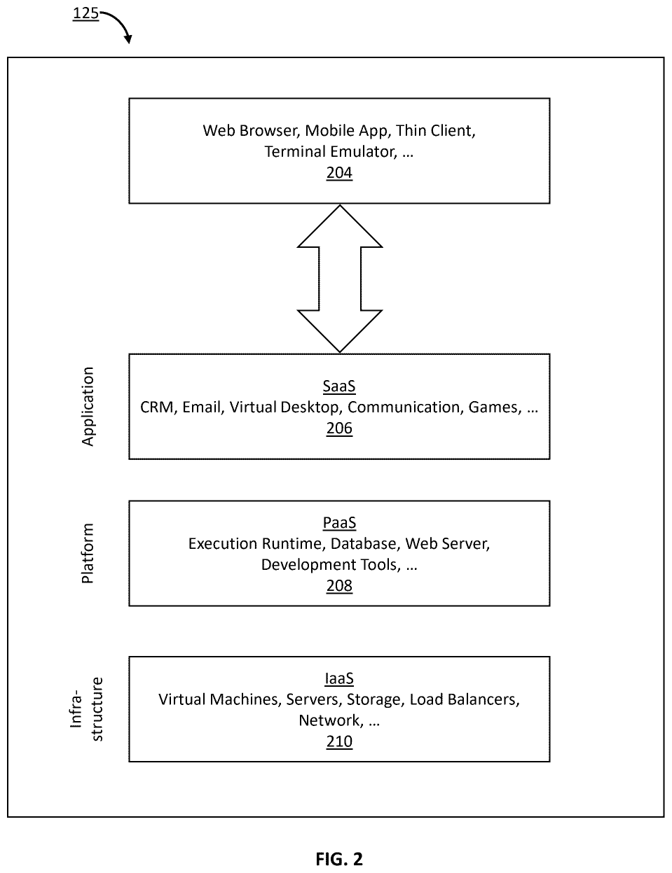

In some embodiments, the exemplary inventive computer-based systems/platforms, the exemplary inventive computer-based devices, and/or the exemplary inventive computer-based components of the present disclosure may be specifically configured to operate in a cloud platform 125 such as, but not limiting to: infrastructure a service (IaaS) 210, platform as a service (PaaS) 208, and/or software as a service (SaaS) 206 using a web browser, mobile app, thin client, terminal emulator or other endpoint 204. FIG. 2 illustrates schematics of exemplary implementations of the cloud platform 125 in which the exemplary inventive computer-based systems/platforms, the exemplary inventive computer-based devices, and/or the exemplary inventive computer-based components of the present disclosure may be specifically configured to operate.

In some embodiments, the cloud platform 125 may include several key components that work together to provide a comprehensive solution for data storage, processing, and distribution. Here are the basic components:

In some embodiments, the cloud platform 125 may include front-end technology 204. The front-end technology 204 may be what the user interacts with when accessing the cloud, e.g., via a client device 102a through 102n. The front-end technology 204 may include the user interface, client devices (such as PCs, laptops, tablets, or mobile phones), and software applications or web browsers (such as, e.g., Chrome™, Firefox™, Safari™).

In some embodiments, a back-end portion of the cloud platform 125 platform may include the technology running behind the scenes in the cloud, which may include servers 104 and/or 113, storage 117 and/or 116, databases 107 and/or 115, and the network 106 infrastructure. The back-end portion may provide for cloud-based delivery, including the provision of delivering the cloud services over the network 106. In some embodiments, the network 106 may be a communication pathway that connects all the components together, such as the internet, an intercloud network, an intranet, or other network or any combination thereof.

In some embodiments, the cloud platform 125 may include infrastructure, such as infrastructure as a service (IaaS) 208, which may include hardware, storage and/or virtualization infrastructure. Hardware may include physical components such as servers, storage, routers, and switches that the cloud service provider manages in real life. Virtualization technology may allow for the creation of virtual machines (VMs), storage, and network resources running on top of the hardware infrastructure to facilitate resource allocation and isolation.

In some embodiments, the cloud platform 125 may include cloud storage via scalable storage solutions, allowing users to increase or decrease their storage capacity as needed. In some embodiments, the storage solution may include, e.g., a suitable memory or storage solutions for maintaining electronic data representing the activity histories for each account. For example, the data storage solution may include database technology such as, e.g., a centralized or distributed database, cloud storage platform, decentralized system, server or server system, among other storage systems. In some embodiments, the storage solution may, additionally or alternatively, include one or more storage devices such as, e.g., a hard drive, solid-state drive, flash drive, or other suitable storage device. In some embodiments, the data storage solution may, additionally or alternatively, include one or more temporary storage devices such as, e.g., a random-access memory, cache, buffer, or other suitable memory device, or any other data storage solution and combinations thereof.

Herein, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

Depending on the database model, one or more database query languages may be employed to retrieve data from the database. Examples of database query languages may include: JSONiq, LDAP, Object Query Language (OQL), Object Constraint Language (OCL), PTXL, QUEL, SPARQL, SQL, XQuery, Cypher, DMX, FQL, Contextual Query Language (CQL), AQL, among suitable database query languages.

The database may include one or more software, one or more hardware, or a combination of one or more software and one or more hardware components forming a database management system (DBMS) that interacts with users, applications, and the database itself to capture and analyze the data. The DBMS software additionally encompasses the core facilities provided to administer the database. The combination of the database, the DBMS and the associated applications may be referred to as a “database system”.

In some embodiments, the cloud platform 125 of the social media platform 100 may include services, e.g., software-as-a-service (SaaS) 206. In cloud computing, what you might be used to thinking of as software and hardware products, become services. These services provide access to the underlying resources.

In some embodiments, the cloud platform 125 may include security measures to protect data and applications in the cloud, such as encryption, identity management, physical security, and network security.

In some embodiments, users may be enrolled or registered on the social media platform 100 using user profiles. The user profiles on social networks are stored using a combination of databases and data collection methods. The user profiles can store user information as data items and/or data objects associated with the user profile. Such information may include, e.g., basic information such as name, age, and location, as well as more detailed data such as interests, online behaviors, and relationships with other users. Additionally, the user profiles may be used to track activities and behaviors on the social media platform 100, such as their posts, and their connections with other users.

In some embodiments, the user profiles may include data objects and/or data items for recording custom preferences. The preferences may include themes and customization options within profiles that configure the social media platform 100 (e.g., the front-end and/or the back-end) to present a customized interface tailored to each user's preferences. This may include personalized layouts, color schemes, font sizes, and other visual elements that enhance the user's overall experience and make the platform more user-friendly.

In some embodiments, the social media platform 100 may store the user profiles in one or more databases or other storage solution or any combination thereof. For example, the database(s) may include relational databases, NoSQL databases, and/or graph databases. For instance, user relationships might be stored in a graph database, while user posts might be stored in a NoSQL database.

In some embodiments, the user profiles may be represented in a graph database. The graph database may be used to represent users and their connections or relationships because graph databases allow efficient querying of relationships between users, making various implementations on social networks based on connection findings, statistics, and analysis feasible and efficient. For example, graph databases can identify “influential users” in a network, recommend new connections (friendships, favorite content) based on commonalities between users, or find different groups of people and communities to profile users.

In some embodiments, a graph database is a type of NoSQL database that uses graph theory to store, map, and query relationships. A graph database may include a collection of nodes and edges, where each node represents an entity, and each edge represents a connection or relationship between two nodes.

The nodes represent entities or instances such as people, businesses, accounts, or any other item to be tracked, including user profiles. Edges, also known as relationships, connect nodes and represent how the nodes are related to each other such as which user profiles are connected to other user profiles attributes of such connections, such as which user follows which, permission level between one user profile and another for viewing user information, among other attributes of the connection or any combination thereof. Indeed, each of the nodes and the edges may include properties that provide additional information about the nodes and edges. For example, a node representing a person might have properties like name, age, or occupation.

The graph database prioritizes relationships, facilitating maintaining the heavily interconnected data of networked user profiles. They are particularly useful when you need to analyze and traverse relationships between data points and when the number and depth of relationships can change over time.

In some embodiments, the social media platform 100 may leverage the graph database(s) for high performance when dealing with data that is highly relational in nature, such as the networking of the user profiles, particularly where the user profiles are aliased, multiplying the number of nodes and edges to track. As such, the graph database may offer superior performance for querying related data, e.g., with an index-free adjacency property, where each node maintains its neighbor nodes information so that no global index about node connections is needed.

In some embodiments, the social media platform 100 may enable a user to update, change, delete or modify data associated with their user profile. Indeed, the database(s) may store the user profile(s) in a schema-less manner, as in a graph database, so that such modifications may be made with adjusting the schema of the database. Accordingly, the user may add, modify and remove user profiles and aliases thereof in an efficient manner.

In some embodiments, the social media platform 100 may include one or more social network analysis (SNA) and/or data modelling models. SNA is a research method used to visualize and analyze relationships and connections between entities or individuals within a network. Thus, SNA enables the social media platform 100 to explore the underlying structure of an organization or network, identifying the formal and informal relationships that drive the formal processes and outcomes. This insight can enable better communication, facilitate change management, and inspire more efficient collaboration.

In some embodiments, the database(s) may store one or more profile aliases associated with a master user profile. The master user profile may include a complete set of the user's information. However, the complete set may include information that is dangerous, inappropriate, or otherwise undesirable to expose in certain contexts. Accordingly, the master user profile may be associated with one or more profile aliases that include one or more different sets of information that subsets of the complete set. Each set may be associated with a context and/or relationship(s) for which the information in the set is associated. Thus, the master user profile may include privacy and connection configurations that affect the connections to other users, encoded as parameters of the graph database node associated with the master user profile. Alternatively or in addition, the privacy and connection configurations may be embodied in user profile aliases connected to the master user profile. Thus, the user profile aliases may form other nodes that have a special connection to the master user profile, including user credentialing for permission to read, write and/or modify, as well as to serve in place of the master user profile. Indeed, in some embodiments, the user may select to connect with, by following or accepting a follow or both, with other user profiles using a particular user profile alias and/or the master user profile itself. Depending on which user profile alias the user selects, the connection with the other user may be provided the set of information associated with the particular user profile alias.

As a result of the one or more user profiles for the user and the connections to other user profiles, the social media platform 100 may build a social graph for the user. The social graph maps user profiles. However, doing so results in exposing user identity to their followers and to those that they follow, which may not be desirable. Indeed, in some cases, a user may wish to hide their information from some followers but reveal their information to other followers, or to selectively reveal certain portions of their information. Thus, embodiments herein utilize a symbolic user profile in place of a user's actual profile in the follower graph and other functions of the platform, the symbolic user profile being the user profile alias that serves as the user profile with respect to particular connections but uses a subset of the user information in the actual or master user profile.

In some embodiments, the user profile aliases may facilitate various other functionalities and/or privacy features. For example, in some embodiments, the social media platform 100 may include a map interface showing a map of one or more areas. The map may include streets, landmarks, buildings, merchants, residential addresses, corporate addresses, infrastructure, natural features, among other locations and structures. In some embodiments, the map interface may be served locations associated with the user profiles, such as the locations of user profiles connected as followers and/or followings of a user's user profile and/or user profile alias(es). The location data may define a current location based on location services on the device associated with each user profile, or by some other location tracking means. As a result, the user of each user profile may be located to the current location associated with each user profile, and as such may be marked on the map interface to depict where the users are located.

However, in some embodiments, some users may select to only show their location in another user's map interface under certain conditions. For example, a first user may set preferences in a first user profile alias to only show the location associated with the first user profile alias when a second user associated with the map interface is also in proximity to that location and that both users are connected. Thus, the second user may see location of the first user, based on the first user profile alias, where the first user follows or is followed by the second user and that both users are in proximity to each other.

In some embodiments, the proximity may include an area around the user accessing the map interface within a predetermined radius (e.g., 0.25 miles, 0.5 miles, 0.75 miles, 1 mile, 2 miles, or more), within a same neighborhood, on a same street, in a same building, at a same restaurant or bar, in the same town, or other boundary or any combination thereof. Thus, as the first user enters into proximity with the second user, the locations of each user may be updated in the user profile alias of each user, and the social media platform 100 may determine that both users in proximity to each other. As a result, the social media platform 100 may serve to the map interface of the second user an indication of the location of the first user, e.g., via a pin or other marker on the map.

In some embodiments, where a user profile alias allows its location to appear in the map interface of another user, the other user may be enabled to select the indication on the map of the user profile alias and view information about the user profile alias, including the set of information associated with that user profile alias. Accordingly, a user may establish multiple user profile aliases with different mapping parameters and privacy settings, such that those follow on user profile alias may see the location associated with that user profile alias than if another user profile alias is followed. The parameters for whether a user's location is served to a mapping interface may include, e.g., proximity, time of day, status of the user profile alias (e.g., set to private, busy, free, do not disturb, etc.), among other parameters or any combination thereof.

In some embodiments, where the second user follows the first user, connections may be formed to multiple user profile aliases of the first user. As a result, the second user may be able to view different sets of information associated with the first user depending on the context. For example, the default user profile alias associated with the connection to the first user may be configured to not show a location indication, but as the users enter into proximity, the default user profile alias may switch to another user profile alias for the connection to the first user and the other user profile alias may allow for the second user to view in the map interface the location of the first user. In some embodiments, the switch from the default user profile alias to the other user profile alias may instead or in addition occur based on proximity of the first and/or second user to a certain location defined by a geographic location, region, landmark, geofence, business, attraction, event location, or other or any combination thereof.

In some embodiments, the switching between user profile aliases may be implemented for public viewing (e.g., to users with which the first has no connection) in order to prevent tracking of the first user unless the first user is in a situation where the first desires to be discoverable and thus meet other users and form a community, such as at a networking event, community event, concert, meeting point (e.g., restaurant, bar, etc.), or other situation or any combination thereof.

Accordingly, the user profile aliases may be implemented for controllable and variable privacy features, including follower mapping that can controllably reveal only certain information. Indeed, the user profile alias associated with revealing location in another users map interface may including parameters to anonymize the first user, thus preventing any information from any of the user's user profile aliases from being viewable, rather only being presented as an anonymous other user in the proximity.

In some embodiments, such mapping functionality may be leveraged for community participation events where multiple users are encouraged to attend a community participation event at a particular place at a particular time. The community participation event may include, e.g., a church function, a community organized event or fundraiser, a sporting event, a concert, a sale at a merchant or shopping center, a party, a demonstration or protest, among other events or any combination thereof. Such events are enhanced when more people attend and participate. Accordingly, the ability to selectively reveal the location of other users attending the event may help to entice participation, even where the reveal is only for the anonymized location indication, which can nevertheless show high levels of participation and greater community involvement, thus increasing the feeling of community.

In one example, the community participation event may be a contest associated with a particular location. The contest can be a time-bound event occurring at a particular location and a particular time where community involvement can result in prizes to an attendee or to another. For example, the contest may be associated with a particular business, neighborhood, street, mall, shopping center, city, event venue, etc. Indeed, such events may be leveraged as fundraisers where increased community involvement can lead to the generation of revenue at participating entities such that those entities, as per their participation, can contribute a portion of the revenue to the fundraiser.

In some embodiments, such contests may include thresholds for level of participation by each user or across all users. For example, aggregate and/or individual activity can be measured by duration of presence in area, frequency of visits to the area, money spent, items purchased, posts about the area or while in the area to a user's feed, among other metrics of participation or any combination thereof. Where the threshold is exceeding, a certain level of prize may be unlocked, either for one or more participants (such as a particular participant achieving the threshold or all participants where an aggregate threshold is met), or to a designated cause, such as medical care, student tuition, or other beneficiary or any combination thereof. In some embodiments, there may be multiple tiers of prizes, one tier of prize, or the prize may scale with the level of participation via a linear or non-linear correlation.

In some embodiments, the prizes may include monetary prizes, digital items, virtual/augmented reality objects, physical items, travel packages, event tickets, among other prizes or any combination thereof. Users on the social media platform 100 may be notified via an alert or an indication in the map interface or both of the scheduling of a contest or other event. A user may then attend the event and a user profile alias may be employed for the event, e.g., for non-follower users, where the user profile alias has parameters for events that allows certain restricted information to be visible to other attendees and/or the event hosts. The social media platform 100 may track the user activity in the user profile alias during the event and aggregate such activity for measuring the activity at the event with respect to the thresholds established for that event. In some embodiments, the social media platform 100 may report such measurements to the event hosts for issuing prizes, or may issue the prizes itself, such as authorizing a payment for a fundraiser.

In some embodiments, the activity thresholds may include a threshold level of time for users to spend in the specified area. For example, users might need to check-in at a particular music festival venue for at least three hours.

In some embodiments, the activity thresholds may include a threshold level for users to visit the area a certain number of times. For instance, a contest might reward users who visit a local bookstore every week for a month.

In some embodiments, the activity thresholds may include a threshold level tied to purchases made. For example, a contest could reward users who purchase a new product or spend above a certain amount at a specific store.

In some embodiments, the activity thresholds may include a threshold level tied to social media activity, such as making posts about the area or while in the area. For instance, a contest might involve posting a creative photo of a landmark or sharing a review of a new local play.

This contest structure provides a flexible framework that can be adapted to various contexts and goals. It encourages user engagement, promotes sponsors and specific locations, and can help build a sense of community on the platform. In some embodiments, to help incentivize participation in the contest, the contest may be sponsored by a celebrity. As a result, the contest may be branded according to the celebrity with messaging issued to users subscribed to the event that originate from or appear to originate from the celebrity to invite them to attend. In some embodiments, the sponsor may be a user on the social media platform 100 and may a user profile alias associated with such sponsorship allowing the sponsor to reveal information specific to the sponsor's sponsorship of the event.

In some embodiments, the user profile aliases may also be employed to facilitate private messaging. Typically, in one-on-one messaging (also term “direct” messaging, or chats), the security and privacy are limited to encryption in some instances. However, sometimes a user may enter into a messaging session with another user where the user wishes to have enhanced privacy and security for that messaging session or with the other user. Thus, the user may control the messaging session to employ a privacy focused user profile alias for selectable or switchable privacy. As a result, the user may select to make a particular persona visible to the other party.

In some embodiments, the user profile alias associated with the messaging session may be based on selection by the user. However, in some embodiments, the user profile alias may be selected based on the context, such as the location of the user, proximity to the other user, whether the other user is a follower or following of the user, the identity of the other user (e.g., whether the other user is on a blacklist, a privacy-enhanced list, a low privacy list, etc.) among other attributes or any combination thereof. Thus, the social media platform 100 and/or the front-end thereof may employ logic rules to the determine the user profile alias associated with messaging session based on the parameters and/or one or more preferences set by the user.

In some embodiments, the messaging session and/or the user profile alias may include a vision-based privacy enhancement. The vision-based privacy enhancement may employ a camera on each device being used for the messaging session to verify the individuals participating int the messaging session. In particular, the vision-based privacy enhancement may record the user in front of the device via the camera during the messaging session such as while the user is typing or upon the user accessing the messaging session. The social media platform 100 and/or front-end thereof may apply computer vision and/or facial recognition models to a video/image stream captured by the camera.

In some embodiments, the computer vision and/or facial recognition models may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
a. define Neural Network architecture/model,
b. transfer the input data to the exemplary neural network model,
c. train the exemplary model incrementally,
d. determine the accuracy for a specific number of timesteps,
e. apply the exemplary trained model to process the newly-received input data,
f. optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, the computer vision and/or facial recognition models may be trained to detect the user participating in the messaging session based on the image/video feed and determine whether the user is authorized to participate in the messaging session. For example, one or more facial recognition models may be trained to recognize users of the social media platform 100 such that a face captured in the image/video feed may be processed to determine whether the face is of the user associated with the user profile alias involved int eh messaging session.

Additionally or alternatively, the computer vision and/or facial recognition models may determine whether one or more users are captured in the image/video feed. Where more than one user is detected, the social media platform 100 and/or front-end thereof may infer that an unauthorized user is viewing the messaging session.

Based on the detection of an unauthorized user, the messaging session may be configured to secure the messages therein to prevent viewing by the unauthorized user by enforcing one or more privacy controls. In some embodiments, the detection of an unauthorized user may also trigger a notification to the other user to notify the other user of the unauthorized user.

In some embodiments, the privacy controls may include preventing the reveal of one or more messages based on content type and/or user selection. For example, the privacy controls may hide the messages (e.g., make the message(s) blank, blurred or otherwise hidden), replace the messages with random false messages, replace the messages with computer-generated false messages, terminate or temporarily close the messaging session, lock the unauthorized user out of the messaging session (e.g., by displaying an access screen requiring authentication via a password or code), among other privacy measures or any combination thereof.

In some embodiments, the false messages may be randomly selected from a library of stock imagery, e.g., stored in one or more databases of the social media platform 100. In some embodiments, the social media platform 100 may include one or more generative artificial intelligence (AI) models, such as a transformer or generative pre-trained transformer (GPT) including one or more large language model(s). The social media platform 100 may generate a call to the generation AI model(s) to automatically generate false content, and insert the false content into the messaging session in place of the actual content.

In some embodiments, a messaging session, based on the preferences of a user profile alias involved in the messaging session, may include additional privacy enhancements. For example, the messaging session may be password protected based on a password set by the user attempting to access the messaging session (e.g., sender and/or recipient). Thus, upon selecting to access the messaging session, a password entry screen may appear requiring the user to enter the password associated with the messaging session and/or the user profile alias, where access is only provided where the password matches to a preestablished password. Additionally or alternatively, content within the messaging session may be password controlled. For example, certain types of content may be restricted until the user enters a password and/or code associated with the content. The password for the messaging session and the password/code for the content may be the same or different depending on the preferences set for the messaging session and/or user profile alias.

In some embodiments, the password/code for the content may be configured to restrict access to content based on type, such as text, video, audio, image, GIF, document, file, among others or any combination thereof. Each content type may have a password/code that may be the same or different between content types. In some embodiments, only certain content types may be password/code protected, such as images, video, documents, etc., so as to ensure that only the recipient can access the content. In some embodiments, the password/code may be applied to any specific item of content and/or any specific message based on user selection by the sender to ensure that some content/messages may be subject to heightened security such as when the content/message includes confidential information.

In some embodiments, where a password or code is entered incorrectly, the message, content and/or messaging session may be immediately deleted or may be deleted after a certain number of attempts. In some embodiments, some messaging sessions may be configured to be deleted upon the messaging session being closed or upon a user associated with the messaging session selects to terminate the messaging session.

In some embodiments, the vision-based privacy triggers may also include or be adapted to include reaction capture. Reaction capture displays the reaction of a recipient to the sender upon opening a message. Thus, upon the recipient receiving a message and opening the messaging session and/or selecting the message (e.g., such as selecting to play a video or audio file), the messaging session may control the recipient's device to take an image or video of the recipient. Upon capturing the image and/or video, the messaging session may automatically transmit the image and/or video back to the sender so that the sender can view the reaction to the message.

In some embodiments, the social media platform 100 may include gift giving functionality. The gifts may include digital and/or physical items, and/or electronic payments via a payment servicer. In some embodiments, a gift may be created as a data object linked to a sender's user profile alias or to a recipient's user profile alias, or both. The gift data object may include parameters such as an expiration, a geofence or other location requirement. Accordingly, a recipient can only receive the gift within the expiration period and/or at the required location. Upon meeting such requirements, the gift may be executed, e.g., by linking the data object to the recipient's user profile alias, instructing the payment servicer to execute the payment, instruct a merchant and/or distributor to issue, ship or otherwise provide the gift, among other actions or any combination thereof so at to provide the gift to the recipient.

In some embodiments, the gift can be anonymized, e.g., by using an anonymous user profile alias to create and send the gift to the recipient. Such anonymous gifts may be employed, e.g., for fundraising campaigns, political donations, crowdfunding, among other anonymous giving scenarios.

In some embodiments, the gift may intended for another user that the sender meets in person but is not connected to on the social media platform 100. Accordingly, the sender may use a camera of a device of the user to take an image of the intended recipient. The computer vision and/or facial recognition models detailed above may process the image to detect and recognize the face of the intended recipient. In some embodiments, based on the recognition of the recipient, the social media platform 100 may query the user profile database to verify the recipient and obtain the user profile alias of the recipient, which may be a default user profile alias for gift giving or other interactions with strangers, such as an anonymous user profile alias.

In some embodiments, a user's user profile alias and/or master user profile may be linked to other data objects for specifying certain types of information. For example, the user's profile(s) may be linked to data objects customized for legal information such as a will. The legal data objects may include attributes and controls configured to protecting the contents of the legal data objects. For example, the legal data objects may include legal contents, such as text, contract terms, clauses, bequeathments of a will, agreement terms, among other legal content or any combination thereof. In some embodiments, such content may be protected by one or more passwords, codes, facial recognition, biometrics among other access control technologies or any combination thereof.

In some embodiments, authenticity of the contents, e.g., of a legal data object may be proven with a signature, such as an e-signature field. The legal data object may include contents having fields for e-signatures. The user may specify for the legal data object the parties having authorization to access, modify and/or delete the legal data object. An e-signature field may be inserted into the content for each party such that each party must sign, via e-signature, in order to prove that the contents are authentic. Where a user attempts to modify or delete contents, the e-signature fields may automatically clear, removing any present e-signature. Thus, the content cannot be authenticated until each party re-signs the e-signature fields. As a result, the content of the legal data object is controlled to ensure that each party verifies the contents in its most current form. In some embodiments, the parties may be parties to an agreement, contract or transaction, legal representation of the user and/or a person having power-of-attorney, a witness, a notary, among others or any combination thereof.

An example of such a legal data object may be for a will listing a set of bequeathments. The will data object may be password protected and/or validated with e-signatures as detailed above. In some embodiments, the user share the will data object with the beneficiaries, with family, with an executor, and/or with any other users that the user may specify. Thus, if needed, the will may be accessible by the specified users.

Various detailed embodiments of the present disclosure, taken in conjunction with the accompanying FIGs., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(TM), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of

the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) Open VMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

Clause 1. A method including: determining, by at least one processor, a first location of a first user based at least in part on a first user device associated with the first user; determining, by the at least one processor, a second location of a second user based at least in part on a second user device associated with the second user; determining, by the at least one processor, that the first location and the second location satisfy at least one proximity requirement associated with a first user profile of the first user, a second user profile of the second user, or both; and causing, by the at least one processor, a map interface presented on the first user device to present an indication of the second user being present at the second location.

Clause 2. A method including: accessing, by at least one processor, a community participation event data object specifying a community participation event having parameters including: a community participation threshold representative of a threshold participation measurement value associated with participation by a community of users, a location associated with the community participation event, at least one prize associated with the community participation event; broadcasting, by the at least one processor via a network, the community participation event data object to the community of users; measuring, by the at least one processor, community participation via a participation measurement of the community of users when at least one user of the community of user is at the location; and automatically facilitating, by the at least one processor, to issue the at least one prize upon the participation measurement meeting the community participation threshold.

Clause 3. A method including: determining, by at least one processor, a context associated with a user activity of a user, the context including at least one attribute indicative of at least one of: an activity type, a location, or another user associated with the user activity, determining, by the at least one processor, at least one user profile alias of the user associated with the context based at least in part on context parameters specified in a master user profile of the user; and controlling, by the at least one processor, privacy controls associated with the user activity based at least in part on using the at least one user profile alias for the user activity.

Clause 4. A method including: initiating, by at least one processor, a messaging session between a sender user and a recipient user; transmitting, by the at least one processor, a message from the sender user to the recipient user via the messaging session; controlling, by the at least one processor, via the messaging session, at least one camera of a recipient user device associated with the recipient user to capture at least one image of the recipient user; and enforcing, by the at least one processor, at least one privacy control of the messaging session based at least in part on whether a facial recognition model confirms that the at least one image includes the recipient user.

Clause 5. A method including: initiating, by at least one processor, a messaging session between a sender user and a recipient user; transmitting, by the at least one processor, a message from the sender user to the recipient user via the messaging session; controlling, by the at least one processor, via the messaging session, at least one camera of a recipient user device associated with the recipient user to capture at least one image of the recipient user; and transmitting, by the at least one processor, the at least one image to the sender user via the messaging session.

Clause 6. A method including: generating, by at least one processor, upon selection by a sender user, at least one gift data object representing a gift to at least one recipient user; generating, by the at least one processor, an anonymized connection between the at least one gift data object and at least one anonymized user profile alias serving as an alias to a master user profile of the sender user; utilizing, by the at least one processor, at least one facial recognition model to identify in at least one image a recipient user for the gift; and generating, by the at least one processor, a recipient connection between the at least one gift data object and at least one recipient user profile alias serving as an alias to a master user profile of the recipient user.

Clause 7. A method including: determining, by at least one processor, a death of a first user associated with a first user profile; accessing, by the at least one processor, a will data object associated with the first user profile based at least in part on the death; determining, by the at least one processor, at least one connection to at least one of: at least one beneficiary user profile associated with at least one beneficiary, at least one executor user profile associated with at least one executor, or at least one family member user profile associated with at least one family member; and controlling, by the at least one processor, at least one privacy parameter of the will data object to enable access by at least one of: the at least one beneficiary user profile associated with the at least one beneficiary, the at least one executor user profile associated with the at least one executor, or the at least one family member user profile associated with the at least one family member.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method, comprising:
storing, by at least one processor in a primary user profile of a first user, a plurality of user profile aliases, each user profile alias associated with a respective subset of user information and a corresponding context parameter;
determining, by the at least one processor, a current context for the first user based on at least one context criterion comprising at least one of:
a location of a first user device associated with the first user, or
a proximity between the first user device and a second user device associated with a second user, and
participation of the first user in an event defined by a community participation event data object;
selecting, by the at least one processor, based at least in part on the determined current context and the context parameters specified in the primary user profile, a selected user profile alias from the plurality of user profile aliases; and
causing, by the at least one processor, a user interface presented on the second user device to display only the subset of user information associated with the selected user profile alias.

2. The method of claim 1, wherein the at least one context criterion comprises a proximity criterion; and
wherein determining that the first location and the second location satisfy the proximity criterion comprises:
determining that a distance between the first user device and the second user device is less than a predetermined distance.

3. The method of claim 1, wherein the plurality of user profile aliases comprises:
at least a professional alias associated with professional context parameters; and
a personal alias associated with personal context parameters.

4. The method of claim 1, wherein selecting the selected user profile alias comprises:
applying a set of selection rules that match the determined current context to the context parameters of each user profile alias.

5. The method of claim 1, further comprising:
storing, by the at least one processor, the determined current context;
detecting, by the at least one processor, a change in the current context; and
reselecting, by the at least one processor, the selected user profile alias in response to the detected change in the current context.

6. The method of claim 1, wherein causing the user interface to display only the subset of user information associated with the selected user profile alias comprises:
restricting, by the user interface, display of any user information not included in the subset of user information.

7. The method of claim 1, wherein the location of the first user device is determined using:
geofencing based on predefined geographic boundaries.

8. The method of claim 1, wherein the user interface comprises:
a map interface configured to present an icon indicating the first user at the first location based on the selected user profile alias.

9. The method of claim 1, wherein the context parameters specified in the primary user profile include at least one of:
a geographic region;
an event identifier; or
a relationship type between the first user and the second user.

10. The method of claim 1, wherein the event defined by the community participation event data object includes:
a participation threshold; and
wherein determining participation comprises:
measuring a presence duration of the first user in the event location; and
comparing the presence duration to the participation threshold.

11. A system, comprising:
at least one processor in communication with at least one non-transitory computer readable medium having instructions stored thereon, wherein the at least one processor, upon execution of the instructions, is configured to
store, in a primary user profile of a first user, a plurality of user profile aliases, each user profile alias associated with a respective subset of user information and a corresponding context parameter;
determine a current context for the first user based on at least one context criterion comprising at least one of:
a location of a first user device associated with the first user, or
a proximity between the first user device and a second user device associated with a second user, and
participation of the first user in an event defined by a community participation event data object;
select based at least in part on the determined current context and the context parameters specified in the primary user profile, a selected user profile alias from the plurality of user profile aliases; and
cause a user interface presented on the second user device to display only the subset of user information associated with the selected user profile alias.

12. The system of claim 11, wherein the at least one context criterion comprises a proximity criterion; and
wherein determining that the first location and the second location satisfy the proximity criterion comprises:
determining that a distance between the first user device and the second user device is less than a predetermined distance.

13. The system of claim 11, wherein the plurality of user profile aliases comprises:
at least a professional alias associated with professional context parameters; and
a personal alias associated with personal context parameters.

14. The system of claim 11, wherein selecting the selected user profile alias comprises:
applying a set of selection rules that match the determined current context to the context parameters of each user profile alias.

15. The system of claim 11, wherein the at least one processor, upon execution of the instructions, is further configured to:
store the determined current context;
detect a change in the current context; and
reselect the selected user profile alias in response to the detected change in the current context.

16. The system of claim 11, wherein causing the user interface to display only the subset of user information associated with the selected user profile alias comprises:
restricting, by the user interface, display of any user information not included in the subset of user information.

17. The system of claim 11, wherein the location of the first user device is determined using:
geofencing based on predefined geographic boundaries.

18. The system of claim 11, wherein the user interface comprises:
a map interface configured to present an icon indicating the first user at the first location based on the selected user profile alias.

19. The system of claim 11, wherein the context parameters specified in the primary user profile include at least one of:
a geographic region;
an event identifier; or
a relationship type between the first user and the second user.

20. The system of claim 11, wherein the event defined by the community participation event data object includes:
a participation threshold; and
wherein determining participation comprises:
measuring a presence duration of the first user in the event location; and
comparing the presence duration to the participation threshold.
